(19) United States
(12) Patent Application Publication
(10) Pub. No.: US 2002/0055087 A1
(43) Pub. Date: May 9, 2002

(54) Calorie counting apparatus

(76) Inventor: Vicki Jo Hardesty, Murrieta, CA (US)

Correspondence Address: Matthew J. Peirce, Esq., 1550 Starlight Canyon Avenue, Las Vagas, NV, 89123, US

(21) Appl. No.: 09/961,123

(22) Filed: Sep. 20, 2001

Related U.S. Application Data
(60) Provisional application No. 60/233,903, filed on Sep. 20, 2000.

(51) Int. Cl. G09B 19/00; G06F 1/00

(52) U.S. Cl. 434/127; 708/131; 128/921

(57) ABSTRACT

A new and improved calorie counter is disclosed which would assist a user in managing the daily intake of protein, fat, carbohydrates, and calories. The present invention would have a protein intake button, a carbohydrate intake button, a fat intake button, and other buttons which would allow a user to keep track of the amount of each that he or she would have eaten in a particular day. A user would have to input the approximate level of carbohydrates, fats, and proteins eaten after each meal, and the present invention would tally these amounts and store them for the duration of a day. At the end of a day, a user could press a “clear” button, which would then erase the accumulated numbers in the memory of the present invention so it could start anew the next day.

### I. BACKGROUND OF THE INVENTION

The present invention is that of a new and improved covering apparatus which would assist a user in managing the daily intake of protein, fat, carbohydrates, and calories.

### II. DESCRIPTION OF THE PRIOR ART

U.S. Pat. No. 5,691,927, issued to Gump, discloses an instrument, preferably hand-held and hand-operated, for quickly and efficiently assisting in the determination of important nutritional information, such as the percentage of protein, fat, and carbohydrates consumed during a given period of time, as well as the total calories consumed.

U.S. Pat. No. 4,575,804, issued to Ratcliff, discloses a calculator for use by cooks, dieters, and others.

U.S. Pat. No. 4,380,802, issued to Segar et al., discloses a net calorie calculating apparatus which is provided for calculating the calories burned by a person, the calories consumed by a person, and the difference therebetween.

### III. SUMMARY OF THE INVENTION

The present invention is that of a new and improved calorie counter which would assist a user in managing the daily intake of protein, fat, carbohydrates, and calories. The present invention would have a protein intake button, a carbohydrate intake button, a fat intake button, and other buttons which would allow a user to keep track of the amount of each that he or she would have eaten in a particular day. A user would have to input the approximate level of carbohydrates, fats, and proteins eaten after each meal, and the present invention would tally these amounts and store them for the duration of a day. At the end of a day, a user could press a “clear” button, which would then erase the accumulated numbers in the memory of the present invention so it could start anew the next day.

There has thus been outlined, rather broadly, the more important features of a calorie counting apparatus in order that the detailed description thereof that follows may be better understood and in order that the present contribution to the art may be better appreciated. There are, of course, additional features of the calorie counting apparatus that will be described hereinafter and which will form the subject matter of the claims appended hereto.

In this respect, before explaining at least one embodiment of the calorie counting apparatus in detail, it is to be understood that the calorie counting apparatus is not limited in its application to the details of construction and to the arrangements of the components set forth in the following description or illustrated in the drawings. The calorie counting apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present calorie counting apparatus. It is important, therefore, that the claims be regard as including such equivalent constructions insofar as they do not depart from the spirit and scope of the present invention.

It is therefore an object of the present invention to provide a calorie counting apparatus which has all of the advantages of the prior art and none of the disadvantages.

It is another object of the present invention to provide a calorie counting apparatus which may be easily and efficiently manufactured and marketed.

It is another object of the present invention to provide a calorie counting apparatus which is of durable and reliable construction.

It is yet another object of the present invention to provide a calorie counting apparatus which is economically affordable and available to the buying public.

It is yet another object of the present invention to provide a calorie counting apparatus which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a top view of the face of the present invention.

### V. DESCRIPTION OF THE PREFERRED EMBODIMENT

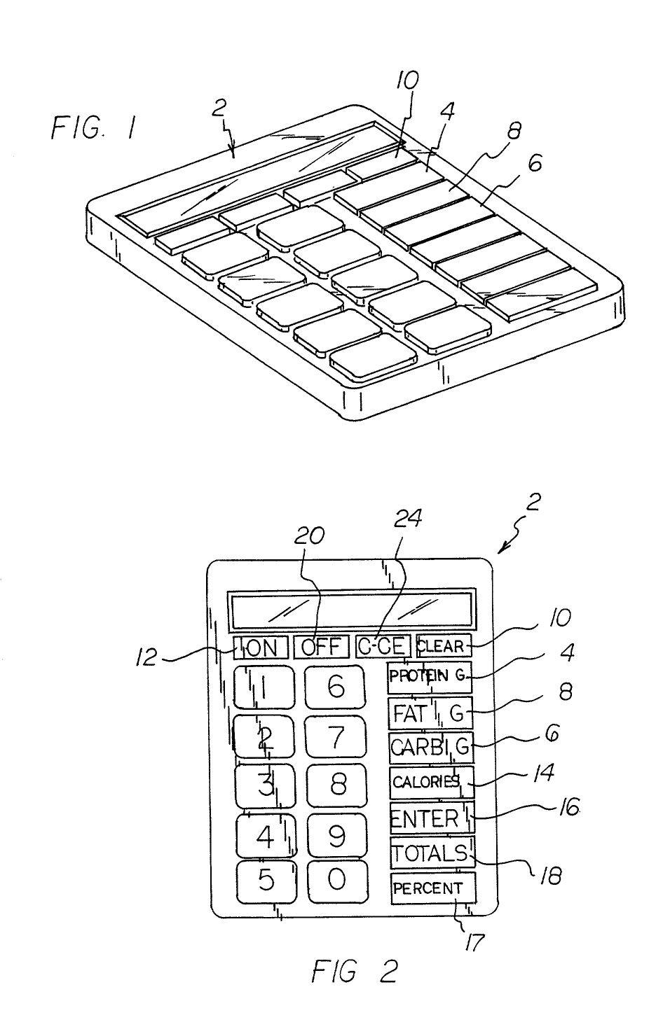

FIG. 1 shows a perspective view of the present invention. The present invention is that of a new and improved calorie counter 2 which would assist a user in managing the daily intake of protein, fat, carbohydrates, and calories. The calorie counter 2 would be shaped like a rectangular box similar to a calculator and would have an outer casing and a display 3. The calorie counter 2 would be powered by at least one battery (not shown) which would be placed within a battery compartment within the outer casing.

The present invention would have a protein intake button 4, a carbohydrate intake button 6, a fat intake button 8, and other buttons which would allow a user to keep track of the amount of each that he or she would have eaten in a particular day. A user would have to input the amount of grams of carbohydrates, fats, and proteins eaten after each meal, and the present invention would tally these amounts and store them for the duration of a day. At the end of a day, a user could press clear button 10, which would then erase the accumulated numbers in the memory of the present invention so it could start anew the next day.

FIG. 2 shows a top view of the face of the present invention. As can be seen, the present invention looks very similar to a calculator.

To use the present invention, a user would first push on button 12. Then, a user would input the grams of protein eaten and push the protein intake button 4. Next, a user would input the grams of fat eaten and push the fat intake button 8. After this, a user would input the grams of carbohydrates eaten and push the carbohydrate intake button 6.

Once a user has inputted this information into calorie counter 2, a user could at any time find out the number of calories consumed for that meal by pushing the calorie button 14 and pushing the enter key 16. In addition, a user could at any time during a particular day push the total button 18 and then pushing the enter key 16 to find out the total amount of calories eaten so far that day.

Further, the user would be able to use percentage button 17, which would allow a user to determine, at the end of a day, what percentage of his or her diet was in fat, protein, and carbohydrates. For example, if a user had consumed 67 grams in fat, 60 grams of protein, and 159 grams of carbohydrates, then the percentages for that particular day would 23% for fat, 21% for protein, and 56% for carbohydrates. These percentages would appear once a user would push percentage button 17.

At any time during the day, a user could push the off key 20 and turn off calorie counter 2. This would not affect the calories and data entered so far that day. Only by pushing the clear button 22 could a user clear out the memory of calorie counter 2 and start anew.

While use the present invention, a user could clear an immediate mistake by pushing the C-CE button 24. This would ensure that the most recent input would be deleted without affecting the current daily total of calories and data already entered.

What I claim as my invention is:

1. A calorie counting apparatus comprising
(a) a rectangular casing, the casing having a front side and a back side,
(b) a battery compartment incorporated into the casing,
(c) at least one battery located within the battery compartment,
(d) a visual display on the front side of the rectangular casing,
(e) a numerical keyboard on the front side of the rectangular casing, the keyboard including a plurality of individual keys representing each number from zero through nine,
(f) an “on” button for turning on power to the calorie counting apparatus, the “on” button located on the front side of the rectangular casing,
(g) an “off” button for turning off power to the calorie counting apparatus, the “off” button located on the front side of the rectangular casing,
(h) a protein intake button for inputting the amount of protein consumed by an individual, the protein intake button located on the front side of the rectangular casing,
(i) a carbohydrate intake button for in putting the amount of carbohydrate consumed by an individual, the carbohydrate intake button located on the front side of the rectangular casing,
(j) a fat intake button for inputting the amount of fat consumed by an individual, the fat intake button located on the front side of the rectangular casing,
(k) a clear button for clearing all data being stored within the calorie counting apparatus, the clear button located on the front side of the rectangular casing,
(l) a calorie button for determining caloric intake based upon data previously inputted in the calorie counting apparatus via the protein intake button, carbohydrate intake button, and the fat intake button, the calorie button located on the front side of the rectangular casing,
(m) an enter key for assisting a user in inputting data into the calorie counting apparatus, the enter key located on the front side of the rectangular casing,
(n) a percentage button for determining percentages of caloric intake based upon data previously inputted in the calorie counting apparatus via the protein intake button, carbohydrate intake button, and the fat intake button, the percentage button located on the front side of the rectangular casing, and
(o) a total button for totaling data previously inputted in the calorie counting apparatus via the protein intake button, carbohydrate intake button, and the fat intake button, the total button located on the front side of the rectangular casing.

2. A process for accumulating and storing numbers of calories consumed in a particular day comprising the steps of:
(a) determining the amount of protein consumed by weight measure for a particular food item or meal,
(b) determining the amount of carbohydrates consumed by weight measure for a particular food item or meal,
(c) determining the amount of fat consumed by weight measure for a particular food item or meal,
(d) converting the weights of each grouping of food into calories, and
(e) repeating steps a) through d) as each additional foot item or meal is consumed in a particular day.

3. A process according to claim 2 wherein the process further comprises the step of displaying the daily cumulative calories consumed upon an action or input performed by an individual.

4. A process for accumulating, storing, and displaying the amount of type of food consumed as a percentage ratio of all food consumed in a particular day comprising the steps of:
(a) determining the amount of protein consumed for a particular food item or meal,
(b) determining the amount of carbohydrates consumed for a particular food item or meal,
(c) determining the amount of fat consumed for a particular food item or meal,
(d) repeating steps a) through d) as each additional foot item or meal is consumed in a particular day,
(e) calculating the percentage of type of food consumed as a percentage ratio of all food consumed in a particular day, and
(f) displaying the calculated percentage on a display.

5. A process for accumulating, storing, and displaying the amount of type of food consumed as a percentage ratio of all food consumed in a particular day according to claim 4 wherein the percentage ratio would be calculated on a weight basis.

6. A process for accumulating, storing, and displaying the amount of type of food consumed as a percentage ratio of all food consumed in a particular day according to claim 5 wherein the particular type of food would be protein.

7. A process for accumulating, storing, and displaying the amount of type of food consumed as a percentage ratio of all food consumed in a particular day according to claim 5 wherein the particular type of food would be fat.

8. A process for accumulating, storing, and displaying the amount of type of food consumed as a percentage ratio of all food consumed in a particular day according to claim 5 wherein the particular type of food would be carbohydrates.

9. A process for accumulating, storing, and displaying the amount of type of food consumed as a percentage ratio of all food consumed in a particular day according to claim 4 wherein the percentage ratio would be calculated on a caloric basis.

10. A process for accumulating, storing, and displaying the amount of type of food consumed as a percentage ratio of all food consumed in a particular day according to claim 9 wherein the particular type of food would be protein.

11. A process for accumulating, storing, and displaying the amount of type of food consumed as a percentage ratio of all food consumed in a particular day according to claim 9 wherein the particular type of food would be fat.

12. A process for accumulating, storing, and displaying the amount of type of food consumed as a percentage ratio of all food consumed in a particular day according to claim 9 wherein the particular type of food would be carbohydrates.
